(19) United States
(12) Patent Application Publication
(10) Pub. No.: US 2026/0351653 A1
(43) Pub. Date: Nov. 5, 2026

(54) APPARATUS AND METHOD FOR MANUFACTURING BATTERY CELLS

(71) Applicant: SK On Co., Ltd., Seoul (KR)

(72) Inventors: Hak Bong MUN, Daejeon (KR); Jae Sik SHIN, Daejeon (KR); Won Je OH, Daejeon (KR); Ki Sang YOO, Daejeon (KR); Moon Hyung JUNG, Daejeon (KR)

(21) Appl. No.: 19/664,096

(22) Filed: Apr. 30, 2026

(30) Foreign Application Priority Data
Apr. 30, 2025 (KR) 10-2025-0057445

(51) Int. Cl. H01M 10/04

(52) U.S. Cl. CPC H01M 10/0409; H01M 10/0431

(57) ABSTRACT

An apparatus for manufacturing battery cells includes: a supply roller continuously supplies a sheet in a first direction in which roll-to-roll travel is performed; a winding core winds the sheet supplied from the supply roller; and a transfer roller is disposed between the supply roller and the winding core to transfer the sheet from the supply roller to the winding core. The transfer roller includes: a first roller rotates about a first rotation shaft; a second roller is disposed at one side of the first roller in a second direction intersecting the first direction to rotate about a second rotation shaft; and a third roller is disposed at the other side of the first roller in the second direction to rotate about a third rotation shaft. The second roller and the third roller are tilted in different rotational directions with respect to the first roller.

### CROSS-REFERENCE TO RELATED PATENT APPLICATION

This application claims priority under 35 U.S.C. § 119(a) to Korean patent application number 10-2025-0057445 filed on Apr. 30, 2025, in the Ministry of Intellectual Property, the entire disclosure of which is incorporated by reference herein.

### TECHNICAL FIELD

This disclosure relates to an apparatus and a method for manufacturing battery cells.

### DISCUSSION OF THE RELATED ART

A jelly-roll that is an intermediate form of a battery is formed by winding a negative electrode and a positive electrode together with a separator disposed therebetween, and alignment between the negative electrode and the positive electrode is important in this process. When the alignment between the negative electrode and the positive electrode is non-uniform, an internal short circuit may occur due to contact between the electrodes. In addition, non-uniformity in alignment may reduce charge and discharge efficiency of the battery and may cause a reduction in battery lifespan.

An apparatus for manufacturing battery cells may have a structure in which sheet-type electrodes and a separator are supplied and wound through a plurality of rollers. However, since the sheets may have localized deformation or waviness during a manufacturing process, misalignment may frequently occur during conveyance and winding. Accordingly, there is a need for measures to ensure precise alignment of the sheets during the conveyance and winding processes.

The foregoing description is provided only to facilitate understanding of the background of the technical idea of this disclosure, and thus should not be understood as constituting prior art known to those of ordinary skill in the art to which this disclosure pertains.

### SUMMARY

An object of this disclosure is to provide an apparatus and a method for manufacturing battery cells, which are capable of achieving alignment between a sheet and a transfer roller without using a sensor for detecting alignment of the sheet and without using a controller and an actuator for controlling a posture of the transfer roller when misalignment of the sheet is detected.

Also, this disclosure may be widely applied to green technology fields, such as Electric Vehicles (EV), battery charging stations, Energy Storage Systems (ESS), and photovoltaic power generation and wind power generation using batteries. In addition, this disclosure may be applied to eco-friendly mobility, including electric vehicles and hybrid vehicles, for preventing climate change by suppressing air pollution and greenhouse gas emissions.

However, the technical problem to be solved by this disclosure is not necessarily limited to the above-described problems, and other technical problems not mentioned herein will be clearly understood by those skilled in the art from the following description.

An apparatus for manufacturing battery cells may include: a supply roller continuously supplies a sheet in a first direction in which roll-to-roll travel is performed; a winding core winds the sheet supplied from the supply roller; and a transfer roller is disposed between the supply roller and the winding core to transfer the sheet from the supply roller to the winding core. The transfer roller includes: a first roller rotates about a first rotation shaft; a second roller is disposed at one side of the first roller in a second direction intersecting the first direction to rotate about a second rotation shaft; and a third roller is disposed at the other side of the first roller in the second direction to rotate about a third rotation shaft. The second roller and the third roller are tilted in different rotational directions with respect to the first roller.

The sheet may include: a first electrode sheet having a first polarity; a second electrode sheet having a second polarity opposite to the first polarity; and a separator disposed between the first electrode sheet and the second electrode sheet on the winding core.

The transfer roller may further include: a first transfer roller configured to support one surface of the sheet; and a second transfer roller configured to support the other surface of the sheet, and the first transfer roller and the second transfer roller may be sequentially arranged in the first direction.

The first roller may support at least a portion of the sheet during the roll-to-roll travel, the second roller may support one side of the sheet in the second direction during the roll-to-roll travel, and the third roller may support the other side of the sheet in the second direction during the roll-to-roll travel.

The transfer roller may include: a first hinge configured to hinge-couple one end of the first rotation shaft and one end of the second rotation shaft; and a second hinge configured to hinge-couple the other end of the first rotation shaft and one end of the third rotation shaft. The second roller may be tilted with respect to the first roller in a first rotational direction about the first hinge, and the third roller may be tilted with respect to the first roller in a second rotational direction opposite to the first rotational direction about the second hinge.

The apparatus may further include: a fixing bracket configured to fix the first hinge and the second hinge; and a lifting bracket configured to raise and lower the other end of the second rotation shaft and the other end of the third rotation shaft in a third direction intersecting the first direction and the second direction.

The fixing bracket may be fixed to a rigid body, and the lifting bracket may be manually operated.

When a first center of the sheet is not aligned with a second center of the transfer roller in the second direction during the roll-to-roll travel, the lifting bracket may raise the other end of the second rotation shaft and the other end of the third rotation shaft, the second roller may be tilted in the first rotational direction about the first hinge by the raising of the lifting bracket, and the third roller may be tilted in the second rotational direction about the second hinge by the raising of the lifting bracket, and the sheet may be guided toward the first roller by the tilting of the second roller and the third roller.

The apparatus may further include: a fixing bracket configured to fix the first hinge and the second hinge; a first lifting bracket configured to raise and lower the other end of the second rotation shaft in a third direction intersecting the first direction and the second direction; and a second lifting bracket configured to raise and lower the other end of the third rotation shaft in the third direction.

The fixing bracket may be fixed to a rigid body, and the first lifting bracket and the second lifting bracket may be manually operated.

When a first center of the sheet is not aligned with a second center of the transfer roller in the second direction during the roll-to-roll travel, one of the first lifting bracket and the second lifting bracket may be selectively raised or lowered according to a direction in which the first center of the sheet is biased relative to the second center of the transfer roller in the second direction during the roll-to-roll travel.

When a first center of the sheet is biased toward the second roller relative to a second center of the transfer roller in the second direction during the roll-to-roll travel, the first lifting bracket may raise the other end of the second rotation shaft, the second roller may be tilted in the first rotational direction about the first hinge by the raising of the lifting bracket, and the sheet may be guided toward the first roller by the tilting of the second roller.

When a first center of the sheet is biased toward the third roller relative to a second center of the transfer roller in the second direction during the roll-to-roll travel, the second lifting bracket may raise the other end of the second rotation shaft, the third roller may be tilted in the second rotational direction about the second hinge by the raising of the lifting bracket, and the sheet may be guided toward the first roller by the tilting of the third roller.

A method for manufacturing battery cells, which winds a jelly-roll by supplying a sheet in a first direction in which roll-to-roll travel is performed, includes: supplying the sheet continuously in the first direction, the sheet being supported by a first roller, a second roller disposed at one side of the first roller in a second direction intersecting the first direction, and a third roller disposed at the other side of the first roller in the second direction; monitoring whether a first center of the sheet is biased in the second direction during the roll-to-roll travel; and guiding the sheet toward the first roller by tilting at least one of the second roller and the third roller when the first center of the sheet is biased in the second direction.

The method may further include aligning the first center of the sheet with a second center of the first roller.

The guiding of the sheet toward the first roller may be performed by manually tilting one of the second roller and the third roller.

The guiding of the sheet toward the first roller may include: guiding one end of the sheet supported by the second roller toward the first roller by tilting the second roller when the first center of the sheet is biased toward the second roller in the second direction; and guiding the other end of the sheet supported by the third roller toward the first roller by tilting the third roller when the first center of the sheet is biased toward the third roller in the second direction.

The tilting of the second roller and the tilting of the third roller may be performed simultaneously.

The tilting of the second roller and the tilting of the third roller may be performed independently.

### BRIEF DESCRIPTION OF THE DRAWINGS

A more complete appreciation of this disclosure and many of the attendant aspects thereof will be readily obtained as the same becomes better understood by reference to the following detailed description when considered in connection with the accompanying drawings, wherein:

FIG. 1 is a schematic conceptual view illustrating an apparatus for manufacturing battery cells according to an embodiment.

FIG. 2 is a schematic exploded perspective view illustrating a detailed configuration of a jelly-roll illustrated in FIG. 1.

FIG. 3 is a schematic conceptual view illustrating an embodiment of the transfer roller illustrated in FIG. 1.

FIG. 4 is a schematic conceptual view illustrating an operation example of the transfer roller illustrated in FIG. 3.

FIG. 5 is a schematic conceptual view illustrating another operation example of the transfer roller illustrated in FIG. 3.

FIG. 6 is a conceptual view illustrating a state in which a sheet is aligned on the transfer roller illustrated in FIG. 3.

FIG. 7 is a schematic conceptual view illustrating another embodiment of the transfer roller illustrated in FIG. 1.

FIG. 8 is a schematic conceptual view illustrating an operation example of the transfer roller illustrated in FIG. 7.

FIG. 9 is a conceptual view illustrating a state in which a sheet is aligned on the transfer roller illustrated in FIG. 8.

FIG. 10 is a schematic conceptual view illustrating another operation example of the transfer roller illustrated in FIG. 7.

FIG. 11 is a conceptual view illustrating a state in which a sheet is aligned to the transfer roller illustrated in FIG. 10.

FIG. 12 is a schematic flowchart illustrating a method for manufacturing battery cells according to an embodiment.

FIG. 13 is a flowchart illustrating process S3 of FIG. 12 in more detail.

### DETAILED DESCRIPTION

Hereinafter, this disclosure will be described in detail with reference to the accompanying drawings. However, the following description is merely illustrative, and this disclosure is not limited to the specific embodiments described herein.

Terms used throughout the specification of this disclosure are provided for the purpose of describing the embodiments and are not necessarily intended to limit this disclosure. The terms of a singular form may include plural forms unless referred to the contrary. Furthermore, when it is described that one comprises (or includes or has) some elements, it should be understood that it may comprise (or include or has) only those elements, or it may comprise (or include or have) other elements as well as those elements if there is no specific limitation.

The terms “at least one of X, Y, and Z” and “at least one selected from the group consisting of X, Y, and Z” may be interpreted as including one of X, one of Y, one of Z, or any combination of two or more of X, Y, and Z (for example, XY, YZ, ZX, XYZ). Herein, “and/or” includes any one or all combinations of one or more of the associated elements.

When a portion is described as being “connected” to another portion, this includes not only a case in which the portion is “directly connected” thereto, but also a case in which the portion is “indirectly connected” thereto with another element interposed therebetween.

Terms such as first and second may be used to describe various elements. These terms are used to distinguish one element from another element when a plurality of elements performing the same function are disposed at different locations. Accordingly, a first element may also be referred to as a second element without departing from the scope of this disclosure.

Hereinafter, various embodiments will be described with reference to schematic drawings. Accordingly, it will be appreciated that shapes thereof may be changed depending on tolerances and/or applicable technologies. Therefore, the embodiments of this disclosure illustrate conceptualized components for convenience of description, and should not be construed as being necessarily limited to specific shapes or sizes. As such, the shapes illustrated in the drawings may not represent actual shapes of regions of an apparatus, and the embodiments of this disclosure are not necessarily limited thereto.

When an embodiment may be implemented in various manners, a specific process sequence may be performed in an order different from the order described. For example, two processes described in succession may be performed substantially simultaneously, or may be performed in an order opposite to the order described.

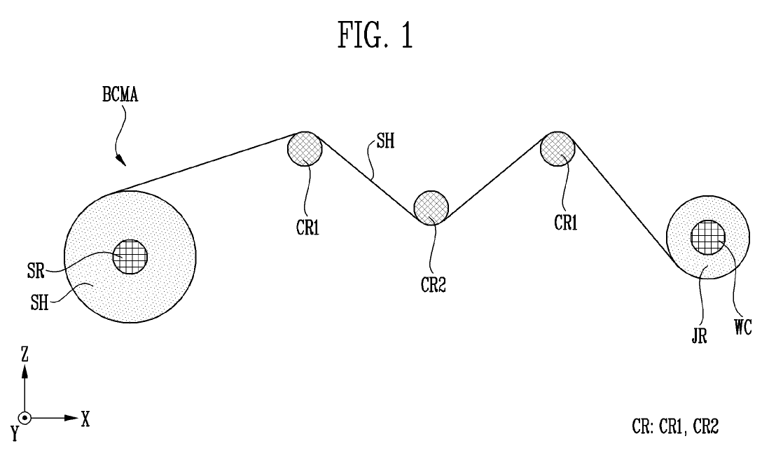

Hereinafter, a battery cell manufacturing apparatus (BCMA) and operation examples thereof will be described with reference to FIGS. 1-11.

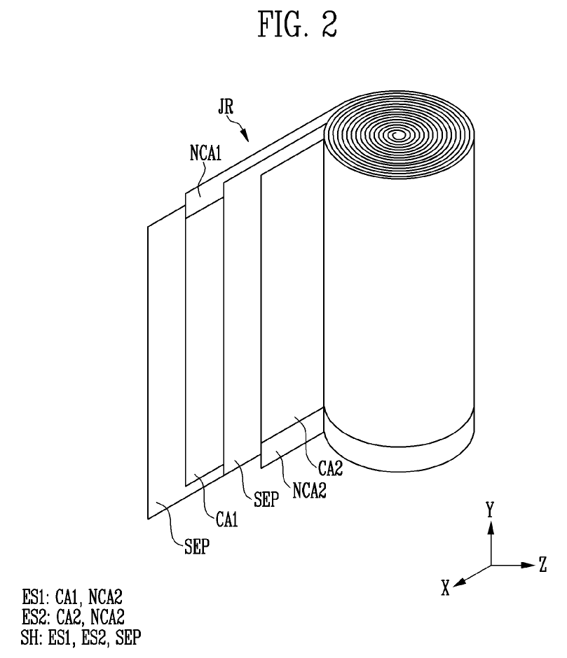

FIG. 1 is a schematic conceptual view illustrating a battery cell manufacturing apparatus according to an embodiment. FIG. 2 is a schematic exploded perspective view illustrating a detailed configuration of a jelly-roll illustrated in FIG. 1.

Referring to FIG. 1, the battery cell manufacturing apparatus (BCMA) according to this disclosure may include a supply roller SR, a winding core WC, and a transfer roller CR.

The supply roller SR may continuously supply a sheet SH in a first direction in which roll-to-roll travel is performed.

The supply roller SR is a component configured to perform roll-to-roll travel, and the sheet SH may be wound along a circumference thereof. The supply roller SR may unwind the sheet SH through a rotational motion and transfer the sheet SH in a roll-to-roll travel direction X.

Referring to FIGS. 1 and 2, the sheet SH may include a first electrode sheet ES1, a second electrode sheet ES2, and a separator SEP.

The first electrode sheet ES1 may have a first polarity. The second electrode sheet ES2 may have a second polarity opposite to the first polarity. The separator SEP may be disposed between the first electrode sheet ES1 and the second electrode sheet ES2 to prevent a short circuit between the first electrode sheet ES1 and the second electrode sheet ES2.

The first electrode sheet ES1, the second electrode sheet ES2, and the separator SEP may be wound around the winding core WC to constitute a jelly roll JR. The jelly roll JR may have a structure in which the first electrode sheet ES1, the separator SEP, the second electrode sheet ES2, and the separator SEP are sequentially stacked at least once in a circumferential direction from a center thereof.

The first electrode sheet ES1 may include a first current collector (not shown) and a first active material layer (not shown) coated on a surface of the first current collector. A portion of the first electrode sheet ES1 on which the active material layer is coated on the surface of the first current collector may be a first coated portion CA1. Another portion of the first electrode sheet ES1 on which the active material layer is not coated on the surface of the first current collector may be a first uncoated portion NCA1.

The first current collector may include a metal as a material thereof. For example, the first current collector may include aluminum (Al) when the first current collector is a positive electrode current collector, and may include copper (Cu) when the first current collector is a negative electrode current collector.

As illustrated in FIG. 2, the first active material layer may be coated on one surface of the first current collector. However, the embodiment of this disclosure is not limited thereto. For example, the first active material layer may be coated on both surfaces of the first current collector. The first active material layer may include a positive electrode active material or a negative electrode active material. The positive electrode active material may include a lithium oxide (LiO) or a high-nickel (High-Ni). The negative electrode active material may include a silicon/carbon (Si/C) composite material.

The first active material layer may be coated on the first coated portion CA1 of the first electrode sheet ES1 and may not be coated on the first uncoated portion NCA1. A width (in a Y direction) of the first active material layer coated on the first coated portion CA1 may be less than that of the first current collector. In other words, the width of the first active material layer coated on the first coated portion CA1 may be less than that of the first current collector based on the Y direction intersecting the roll-to-roll travel direction (X direction). A portion of the first uncoated portion NCA1 may be removed during slitting and notching processes in an electrode manufacturing process to be processed into an electrode tab (not shown).

The second electrode sheet ES2 may include a second current collector (not shown) and a second active material layer (not shown) coated on a surface of the second current collector. A portion of the second electrode sheet ES2 on which the active material layer is coated on the surface of the second current collector may be a second coated portion CA2. Another portion of the second electrode sheet ES2 on which the active material layer is not coated on the surface of the second current collector may be a second uncoated portion NCA2.

The second current collector may include a metal as a material thereof. For example, the second current collector may include aluminum (Al) when the second current collector is a positive electrode current collector, and may include copper (Cu) when the second current collector is a negative electrode current collector.

As illustrated in FIG. 2, the second active material layer may be coated on one surface of the second current collector. However, the embodiment of this disclosure is not limited thereto. For example, the second active material layer may be coated on both surfaces of the second current collector. The second active material layer may include a positive electrode active material or a negative electrode active material. The positive electrode active material may include a lithium oxide (LiO) or a high-nickel (High-Ni). The negative electrode active material may include a silicon/carbon (Si/C) composite material.

The second active material layer may be coated on the second coated portion CA2 of the second electrode sheet ES2 and may not be coated on the second uncoated portion NCA2. A width (in the Y direction) of the second active material layer coated on the second coated portion CA2 may be less than that of the second current collector. In other words, the width of the second active material layer coated on the second coated portion CA2 may be less than that of the second current collector based on the Y direction intersecting the roll-to-roll travel direction (X direction). A portion of the second uncoated portion NCA2 may be removed during the slitting and notching processes in the electrode manufacturing process to be processed into an electrode tab (not shown).

The separator SEP may be disposed between the first electrode sheet ES1 and the second electrode sheet ES2 to allow ions to pass therethrough while preventing a short circuit between the first electrode sheet ES1 and the second electrode sheet ES2. The separator SEP may be a porous membrane made of polyolefin-based polyethylene (PE) and polypropylene (PP). In addition, a ceramic may be coated on a surface of the porous membrane.

The winding core WC may wind the sheet SH supplied from the supply roller SR. Although it is illustrated in FIG. 1 that one sheet SH is supplied from one supply roller SR, the embodiment of this disclosure is not limited thereto. For example, the winding core WC may be connected to four supply rollers SR, each configured to wind and unwind a corresponding one of four sheets SH including the first electrode sheet ES1, the second electrode sheet ES2, and two separators SEP constituting the jelly roll JR of FIG. 2.

The transfer roller CR may be disposed between the supply roller SR and the winding core WC to convey the sheet SH from the supply roller SR to the winding core WC.

The transfer roller CR may include a first transfer roller CR1 configured to support one surface of the sheet SH and a second transfer roller CR2 configured to support the other surface of the sheet SH.

The first transfer roller CR1 and the second transfer roller CR2 may be sequentially arranged in the direction (X direction) in which roll-to-roll travel is performed. Although it is illustrated in FIG. 1 that the first transfer roller CR1, the second transfer roller CR2, and the first transfer roller CR1 are sequentially arranged in the direction (X direction) in which roll-to-roll travel is performed, the embodiment of this disclosure is not limited thereto. For example, at least one transfer roller CR may be disposed between the supply roller SR and the winding core WC. The transfer roller CR that is a component configured to maintain tension of the sheet SH and align the sheet SH while the sheet SH is conveyed from the supply roller SR to the winding core WC may be disposed in an appropriate number depending on a spaced distance between the supply roller SR and the winding core WC.

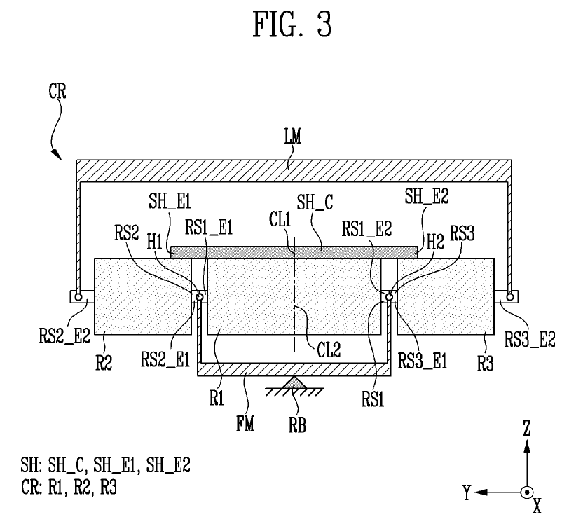

Hereinafter, a detailed configuration of the transfer roller CR will be described with reference to FIG. 3. Hereinafter, for convenience of description, the roll-to-roll travel direction (X direction) will be referred to as a first direction, a width direction (Y direction) of the sheet SH will be referred to as a second direction, and a thickness direction (Z direction) of the sheet SH will be referred to as a third direction. In other words, the second direction Y may be a direction intersecting the first direction X, and the third direction Z may be a direction intersecting both the first direction X and the second direction Y.

FIG. 3 is a schematic conceptual view illustrating an embodiment of the transfer roller shown in FIG. 1.

The transfer roller CR may include a first roller R1, a second roller R2, and a third roller R3.

The first roller R1 may rotate about a first rotation shaft RS1. The first rotation shaft RS1 may extend in the second direction Y.

The first roller R1 may support at least a portion of the sheet SH during roll-to-roll travel. For example, the first roller R1 may support a central portion SH_C of the sheet SH adjacent to a first center CL1 of the sheet SH during roll-to-roll travel.

The second roller R2 may be disposed at one side of the first roller R1 in the second direction Y intersecting the first direction X, and may rotate about a second rotation shaft RS2. The second rotation shaft RS2, as with the first rotation shaft RS1, may extend in the second direction Y.

The second roller R2 may support one side of the sheet SH in the second direction Y during roll-to-roll travel. For example, the second roller R2 may support one end SH_E1 of the sheet SH during roll-to-roll travel.

The third roller R3 may be disposed at the other side of the first roller R1 in the second direction Y, and may rotate about a third rotation shaft RS3. The third rotation shaft RS3, as with the first and second rotation shafts RS1 and RS2, may extend in the second direction Y.

The third roller R3 may support the other side of the sheet SH in the second direction Y during roll-to-roll travel. For example, the third roller R3 may support the other end SH_E2 of the sheet SH during roll-to-roll travel.

The second roller R2 and the third roller R3 may be tilted in different directions with respect to the first roller R1. For example, the second roller R2 may rotate in a clockwise direction with respect to the first roller R1, and the third roller R3 may rotate in a counterclockwise direction with respect to the first roller R1.

The transfer roller CR may further include a first hinge H1 and a second hinge H2.

The first hinge H1 may hinge-couple one end RS1_E1 of the first rotation shaft RS1 and one end RS2_E1 of the second rotation shaft RS2. The second hinge H2 may hinge-couple the other end RS1_E2 of the first rotation shaft RS1 and one end RS3_E1 of the third rotation shaft RS3.

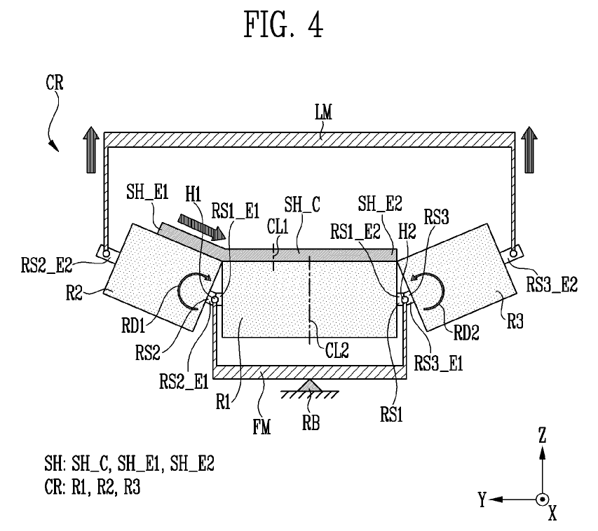

The second roller R2 may be tilted with respect to the first roller R1 in a first rotational direction RD1 (refer to FIG. 4) about the first hinge H1. The third roller R3 may be tilted with respect to the first roller R1 in a second rotational direction RD2 (refer to FIG. 4) about the second hinge H2.

The battery cell manufacturing apparatus (BCMA) according to this disclosure may further include a fixing bracket FM and a lifting bracket LM.

The fixing bracket FM may fix the first hinge H1 and the second hinge H2. To this end, the fixing bracket FM may be fixed to a rigid body RB.

The lifting bracket LM may raise or lower the other end RS2_E2 of the second rotation shaft RS2 and the other end RS3_E2 of the third rotation shaft RS3 in the third direction Z intersecting the first direction X and the second direction Y. The lifting bracket LM may be operated manually. However, the embodiment of this disclosure is not limited thereto. For example, the lifting bracket LM may be raised or lowered by a worker applying a physical force directly thereto. As another example, the lifting bracket LM may be connected to a driving device such as a step motor and may be raised or lowered in response to manipulation of a signal transmission medium such as a button.

FIG. 3 is a view illustrating a state in which roll-to-roll travel is being performed in a condition in which a first center CL1 of the sheet SH and a second center CL2 of the transfer roller CR are aligned with each other in the second direction Y. In other words, the sheet SH may perform the roll-to-roll travel in a state in which the first center CL1 of the sheet SH and the second center CL2 of the transfer roller CR overlap in the third direction Z, and such a state may be recognized as a normal operation state.

When the first center CL1 of the sheet SH is not aligned with the second center CL2 of the transfer roller CR in the second direction Y during the roll-to-roll travel, the lifting bracket LM may raise the other end RS2_E2 of the second rotation shaft RS2 and the other end RS3_E2 of the third rotation shaft RS3. Accordingly, the second roller R2 may be tilted in a first rotational direction RD1 (refer to FIG. 4) about the first hinge H1 by the raising of the lifting bracket LM. In addition, the third roller R3 may be tilted in the second rotational direction RD2 (refer to FIG. 4) about the second hinge H2 by the raising of the lifting bracket LM. The tilting of the second roller R2 and the third roller R3 may guide the sheet SH toward the first roller R1.

In other words, the battery cell manufacturing apparatus (BCMA) according to this disclosure may align the first center CL1 of the sheet SH with the second center CL2 of the transfer roller CR by guiding the sheet SH toward the first roller R1 through tilting of the second and third rollers R2 and R3. According to such a configuration, alignment between the sheet SH and the transfer roller CR may be achieved without using a sensor for detecting alignment of the sheet and without using a controller and an actuator for controlling a posture of the transfer roller when misalignment of the sheet is detected. Accordingly, an overall configuration of equipment may be simplified, and costs required for providing the sensor, the controller, and the actuator, as well as maintenance costs thereof, may be reduced.

Hereinafter, how the lifting bracket LM and the transfer roller CR operate to adjust the system to a normal operation state when the first center CL1 of the sheet SH is not aligned with the second center CL2 of the transfer roller CR in the second direction Y during roll-to-roll travel will be described with reference to FIGS. 4-6.

FIG. 4 is a schematic conceptual view illustrating an operation example of the transfer roller illustrated in FIG. 3.

Referring to FIG. 4, the first center CL1 of the sheet SH may be biased toward the second roller R2 during roll-to-roll travel.

In this case, the lifting bracket LM may raise the other end RS2_E2 of the second rotation shaft RS2 and the other end RS3_E2 of the third rotation shaft RS3. According to the operation of the lifting bracket LM, the second roller R2 may be tilted in the first rotational direction RD1 about the first hinge H1. In addition, the third roller R3 may be tilted in the second rotational direction RD2 about the second hinge H2.

By such tilting of the second roller R2 and the third roller R3, the sheet SH may receive a force directed toward the first roller R1. Accordingly, one end SH_E1 of the sheet SH may move toward the first roller R1 until the first center CL1 of the sheet SH is aligned with the second center CL2 of the transfer roller CR.

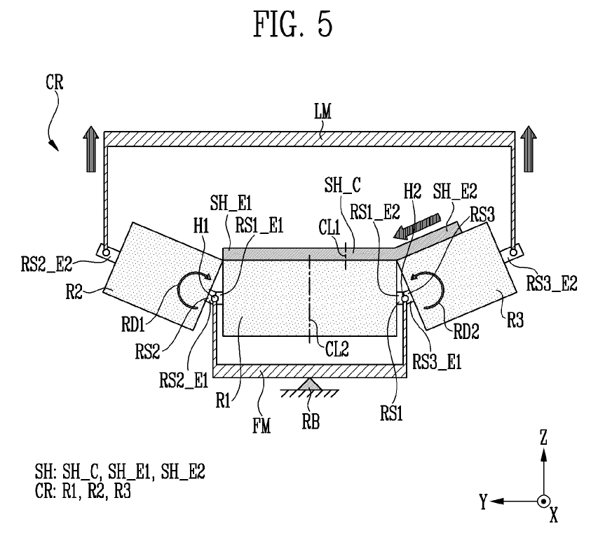

FIG. 5 is a schematic conceptual view illustrating another operation example of the transfer roller illustrated in FIG. 3.

Referring to FIG. 5, the first center CL1 of the sheet SH may be biased toward the third roller R3 during roll-to-roll travel.

In this case, the lifting bracket LM may raise the other end RS2_E2 of the second roller R2 and the other end RS3_E2 of the third roller R3. According to the operation of the lifting bracket LM, the second roller R2 may rotate in the first rotational direction RD1 about the first hinge H1. In addition, the third roller R3 may rotate in the second rotational direction RD2 about the second hinge H2. By such tilting of the second roller R2 and the third roller R3, the sheet SH may receive a force directed toward the first roller R1. Accordingly, the other end SH_E2 of the sheet SH may move toward the first roller R1 until the first center CL1 of the sheet SH is aligned with the second center CL2 of the transfer roller CR.

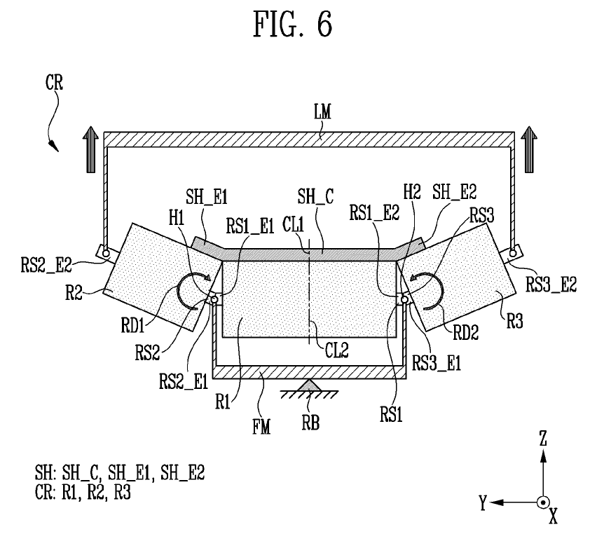

FIG. 6 is a conceptual view illustrating a state in which a sheet is aligned to the transfer roller illustrated in FIG. 3.

Referring to FIG. 6, the first center CL1 of the sheet SH may be aligned with the second center CL2 of the transfer roller CR by the raising of the lifting bracket LM and the tilting of the second and third rollers R2 and R3. When the first center CL1 of the sheet SH is aligned with the second center CL2 of the transfer roller CR, the lifting bracket LM may be lowered again. As the lifting bracket LM is lowered, tilting of the second and third rollers R2 and R3 may also be released.

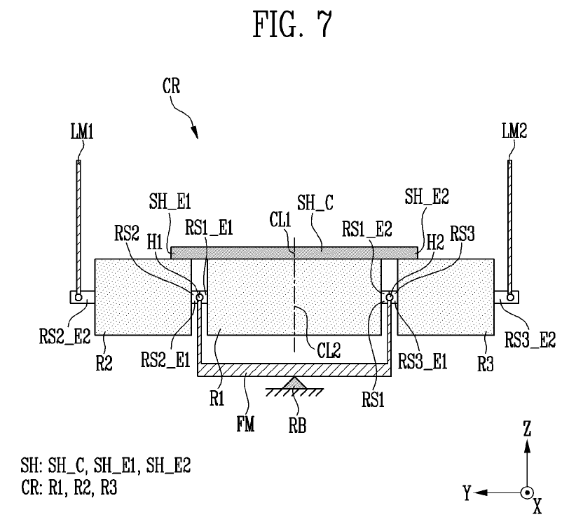

FIG. 7 is a schematic conceptual view illustrating another embodiment of the transfer roller illustrated in FIG. 1.

The battery cell manufacturing apparatus (BCMA) according to this disclosure may further include a fixing bracket FM, a first lifting bracket LM1, and a second lifting bracket LM2.

Except for the first lifting bracket LM1 and the second lifting bracket LM2 illustrated in FIG. 7, the remaining components may be configured identically to corresponding components illustrated in FIG. 3. Accordingly, technical features described with reference to the corresponding components of FIG. 3 will be incorporated herein, and detailed descriptions thereof will be omitted for brevity.

The first lifting bracket LM1 may raise or lower the other end RS2_E2 of the second rotation shaft RS2 in the third direction Z intersecting the first direction X and the second direction Y. The first lifting bracket LM1 may be operated manually. However, the embodiment of this disclosure is not limited thereto. For example, the first lifting bracket LM1 may be raised or lowered by a worker applying a physical force directly thereto. As another example, the first lifting bracket LM1 may be connected to a driving device such as a step motor and may be raised or lowered in response to manipulation of a signal transmission medium such as a button.

The second lifting bracket LM2 may raise or lower the other end RS3_E2 of the third rotation shaft RS3 in the third direction Z. The second lifting bracket LM2, as with the first lifting bracket LM1, may be operated manually. However, the embodiment of this disclosure is not limited thereto. For example, the second lifting bracket LM2 may be raised or lowered by a worker applying a physical force directly thereto. As another example, the second lifting bracket LM2 may be connected to a driving device such as a step motor and may be raised or lowered in response to manipulation of a signal transmission medium such as a button.

FIG. 7 is a view illustrating a state in which roll-to-roll travel is being performed in a condition in which a first center CL1 of the sheet SH and a second center CL2 of the transfer roller CR are aligned with each other in the second direction Y. In other words, the sheet SH may perform the roll-to-roll travel in a state in which the first center CL1 of the sheet SH and the second center CL2 of the transfer roller CR overlap in the third direction Z, and such a state may be recognized as a normal operation state.

When the first center CL1 of the sheet SH is not aligned with the second center CL2 of the transfer roller CR in the second direction Y during roll-to-roll travel, one of the first lifting bracket LM1 and the second lifting bracket LM2 may be selectively raised according to a direction in which the first center CL1 of the sheet SH is biased relative to the second center CL2 of the transfer roller CR in the second direction Y.

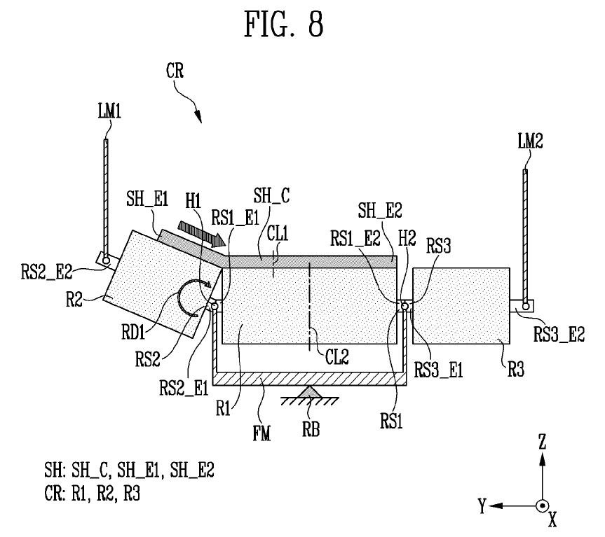

For example, when the first center CL1 of the sheet SH is biased toward the second roller R2 relative to the second center CL2 of the transfer roller CR in the second direction Y during roll-to-roll travel, the first lifting bracket LM1 may raise the other end RS2_E2 of the second rotation shaft RS2. Accordingly, the second roller R2 may be tilted in the first rotational direction RD1 (refer to FIG. 8) about the first hinge H1 by the raising of the first lifting bracket LM1. The tilting of the second roller R2 may guide the sheet SH toward the first roller R1.

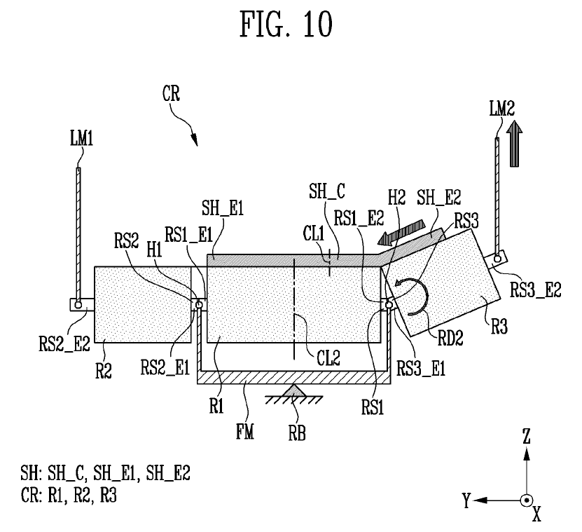

As another example, when the first center CL1 of the sheet SH is biased toward the third roller R3 relative to the second center CL2 of the transfer roller CR in the second direction Y during roll-to-roll travel, the second lifting bracket LM2 may raise the other end RS3_E2 of the third rotation shaft RS3. Accordingly, the third roller R3 may be tilted in the second rotational direction RD2 (refer to FIG. 10) about the second hinge H2 by the raising of the second lifting bracket LM2. By such tilting of the third roller R3, the sheet SH may be guided toward the first roller R1.

In other words, the battery cell manufacturing apparatus (BCMA) according to this disclosure may align the first center CL1 of the sheet SH with the second center CL2 of the transfer roller CR by guiding the sheet SH toward the first roller R1 through tilting of the second roller R2 or the third roller R3. According to such a configuration, alignment between the sheet SH and the transfer roller CR may be achieved without using a sensor for detecting alignment of the sheet and without using a controller and an actuator for controlling a posture of the transfer roller when misalignment of the sheet is detected. Accordingly, an overall configuration of equipment may be simplified, and costs required for providing the sensor, the controller, and the actuator, as well as maintenance costs thereof, may be reduced.

Hereinafter, how the lifting bracket LM and the transfer roller CR operate to adjust the system to a normal operation state when the first center CL1 of the sheet SH is not aligned with the second center CL2 of the transfer roller CR in the second direction Y during roll-to-roll travel will be described with reference to FIGS. 8-11.

FIG. 8 is a schematic conceptual view illustrating an operation example of the transfer roller illustrated in FIG. 7.

Referring to FIG. 8, the first center CL1 of the sheet SH may be biased toward the second roller R2 during roll-to-roll travel.

In this case, the first lifting bracket LM1 may raise the other end RS2_E2 of the second rotation shaft RS2. According to the operation of the first lifting bracket LM1, the second roller R2 may be tilted in the first rotational direction RD1 about the first hinge H1.

By such tilting of the second roller R2, the sheet SH may receive a force directed toward the first roller R1. Accordingly, one end SH_E1 of the sheet SH may move toward the first roller R1 until the first center CL1 of the sheet SH is aligned with the second center CL2 of the transfer roller CR.

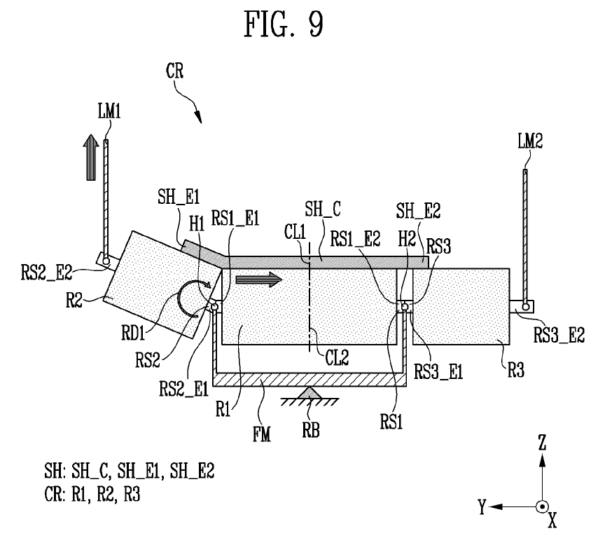

FIG. 9 is a conceptual view illustrating a state in which a sheet is aligned on the transfer roller illustrated in FIG. 8.

Referring to FIG. 9, the first center CL1 of the sheet SH may be aligned with the second center CL2 of the transfer roller CR by the raising of the first lifting bracket LM1 and the tilting of the second roller R2. When the first center CL1 of the sheet SH is aligned with the second center CL2 of the transfer roller CR, the first lifting bracket LM1 may be lowered again. As the first lifting bracket LM1 is lowered, tilting of the second roller R2 may also be released.

FIG. 10 is a schematic conceptual view illustrating another operation example of the transfer roller illustrated in FIG. 7.

Referring to FIG. 10, the first center CL1 of the sheet SH may be biased toward the third roller R3 during roll-to-roll travel.

In this case, the second lifting bracket LM2 may raise the other end RS3_E2 of the third rotation shaft RS3. According to the operation of the second lifting bracket LM2, the third roller R3 may be tilted in the second rotational direction RD2 about the second hinge H2.

By such tilting of the third roller R3, the sheet SH may receive a force directed toward the first roller R1. Accordingly, the other end SH_E2 of the sheet SH may move toward the first roller R1 until the first center CL1 of the sheet SH is aligned with the second center CL2 of the transfer roller CR.

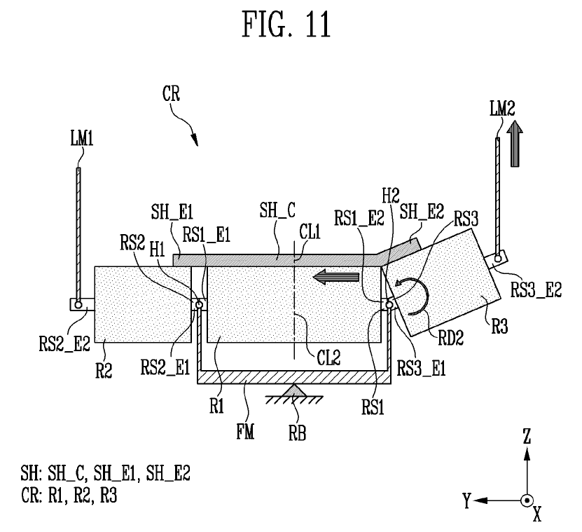

FIG. 11 is a conceptual view illustrating a state in which a sheet is aligned to the transfer roller illustrated in FIG. 10.

Referring to FIG. 11, the first center CL1 of the sheet SH may be aligned with the second center CL2 of the transfer roller CR by the raising of the second lifting bracket LM2 and the tilting of the third roller R3. When the first center CL1 of the sheet SH is aligned with the second center CL2 of the transfer roller CR, the second lifting bracket LM2 may be lowered again. As the second lifting bracket LM2 is lowered, tilting of the third roller R3 may also be released.

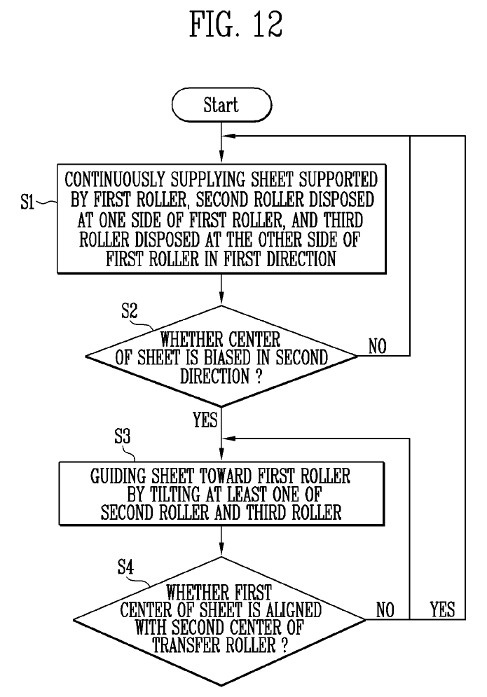

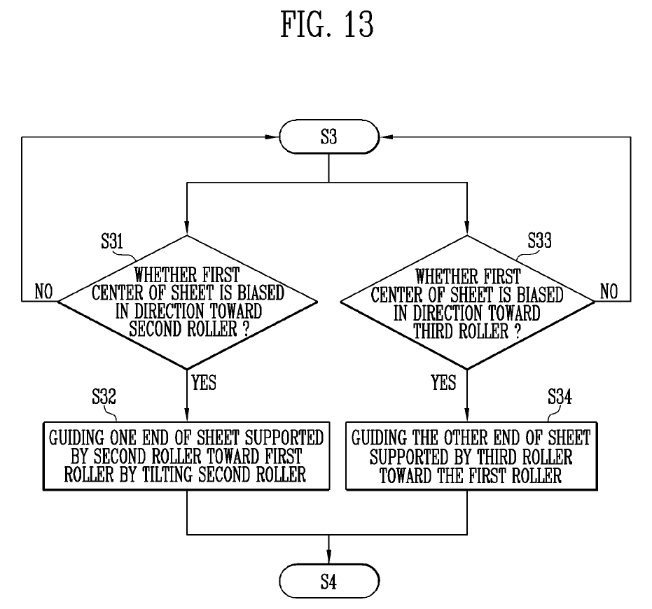

Hereinafter, a method for manufacturing battery cells using the above-described battery cell manufacturing apparatus (BCMA) according to this disclosure will be described with reference to FIGS. 12 and 13.

FIG. 12 is a schematic flowchart illustrating a method for manufacturing battery cells according to an embodiment. FIG. 13 is a flowchart illustrating process S3 of FIG. 12 in more detail.

Referring to FIG. 12, the method for manufacturing battery cells according to this disclosure relates to a method for manufacturing battery cells in which a sheet SH is supplied in a first direction X while roll-to-roll travel is performed and a jelly-roll is wound. The method may include: a process S1 of continuously supplying the sheet SH supported by a first roller R1, a second roller R2 disposed at one side of the first roller R1, and a third roller R3 disposed at the other side of the first roller R1 in the first direction X; a process S2 of monitoring whether a center of the sheet SH is biased in a second direction Y; and a process S3 of guiding the sheet SH toward the first roller R1 by tilting at least one of the second roller R2 and the third roller R3 when the center of the sheet SH is biased in the second direction Y during roll-to-roll travel.

The process S1 may correspond to the normal operation state described above with reference to FIGS. 3 and 7. In other words, the process S1 may correspond to a state in which correction of misalignment between the first center CL1 of the sheet SH and the second center CL2 of the transfer roller CR, as performed in processes S2 to S4, is not required.

The process S2 that is a process of continuously monitoring an alignment state between the sheet SH and the transfer roller CR may be visually checked by an operator. However, the embodiment of this disclosure is not limited thereto. For example, a separate sensor may be provided to detect the alignment state of the first center CL1 of the sheet SH and the second center CL2 of the transfer roller CR, thereby enabling the operator to recognize the presence of misalignment solely through a configuration or means that allows such recognition.

The process S3 may be performed by raising and lowering of the lifting bracket LM or the first lifting bracket LM1 and the second lifting bracket LM2, and by tilting of the second roller R2 and/or the third roller R3 in response thereto, as described above with reference to FIGS. 4-6 and 8-11. The process S3 may be performed by manually tilting one of the second roller R2 and the third roller R3.

Referring to FIGS. 12 and 13 together, the process S3 may include: a process S32 of guiding one end SH_E1 of the sheet SH supported by the second roller R2 toward the first roller R1 by tilting the second roller R2 in a case S31 in which the first center CL1 of the sheet SH is biased in a direction toward the second roller R2 in the second direction Y; and a process S34 of guiding the other end SH_E2 of the sheet SH supported by the third roller R3 toward the first roller R1 by tilting the third roller R3 in a case S33 in which the first center CL1 of the sheet SH is biased in a direction toward the third roller R3 in the second direction Y.

As illustrated in FIGS. 4 -6, the process S32 of tilting the second roller R2 and the process S34 of tilting the third roller R3 may be performed simultaneously.

As illustrated in FIGS. 8-11, the process S32 of tilting the second roller R2 and the process S34 of tilting the third roller R3 may also be performed independently.

The method for manufacturing battery cells according to this disclosure may further include process S4 of determining whether the first center CL1 of the sheet SH is aligned with the second center CL2 of the transfer roller CR.

In the process S4, when it is determined that the first center CL1 of the sheet SH is aligned with the second center CL2 of the transfer roller CR, the process may return to the process S1 to maintain a normal operation state.

On the other hand, when it is determined that the first center CL1 of the sheet SH is not yet aligned with the second center CL2 of the transfer roller CR, the process may return to the process S3 to maintain a state in which at least one of the second roller R2 and the third roller R3 is tilted so as to continuously guide the sheet SH toward the first roller R1, and thereafter the process S4 may be performed again.

In other words, the method for manufacturing battery cells according to this disclosure may align the first center CL1 of the sheet SH with the second center CL2 of the transfer roller CR by guiding the sheet SH toward the first roller R1 through tilting of the second and third rollers R2 and R3. According to the above-described method, the alignment between the sheet SH and the transfer roller CR may be achieved without using a sensor for detecting alignment of the sheet and without using a controller and an actuator for controlling a posture of the transfer roller when misalignment of the sheet is detected. Accordingly, an overall configuration of equipment may be simplified, and costs required for providing the sensor, the controller, and the actuator, as well as maintenance costs thereof, may be reduced.

According to the embodiment of this disclosure, the alignment between the sheet and the transfer roller may be achieved without using the sensor for detecting alignment of the sheet and without using the controller and the actuator for controlling the posture of the transfer roller when the misalignment of the sheet is detected. Accordingly, the overall configuration of equipment may be simplified, and the costs required for providing the sensor, the controller, and the actuator, as well as the maintenance costs thereof, may be reduced.

However, the effects of this disclosure are not necessarily limited to the above-described effects, and may be variously expanded without departing from the spirit and scope of this disclosure.

The scope of this disclosure is defined by the following claims rather than the foregoing detailed description, and all changes or modified forms derived from the meanings, the scope, and the equivalent concept of the claims are to be construed as being included in the scope of this disclosure.

What is claimed is:

1. An apparatus for manufacturing battery cells, the apparatus comprising:
a supply roller configured to continuously supply a sheet in a first direction in which roll-to-roll travel is performed;
a winding core configured to wind the sheet supplied from the supply roller; and
a transfer roller disposed between the supply roller and the winding core to transfer the sheet from the supply roller to the winding core,
wherein the transfer roller comprises:
a first roller configured to rotate about a first rotation shaft;
a second roller disposed at one side of the first roller in a second direction intersecting the first direction to rotate about a second rotation shaft; and
a third roller disposed at the other side of the first roller in the second direction to rotate about a third rotation shaft,
wherein the second roller and the third roller are configured to be tilted in different rotational directions with respect to the first roller.

2. The apparatus of claim 1, wherein the sheet comprises:
a first electrode sheet having a first polarity;
a second electrode sheet having a second polarity opposite to the first polarity; and
a separator disposed between the first electrode sheet and the second electrode sheet on the winding core.

3. The apparatus of claim 1, wherein the transfer roller further comprises:
a first transfer roller configured to support one surface of the sheet; and
a second transfer roller configured to support the other surface of the sheet,
wherein the first transfer roller and the second transfer roller are sequentially arranged in the first direction.

4. The apparatus of claim 1, wherein the first roller configured to support at least a portion of the sheet during the roll-to-roll travel,
the second roller configured to support one side of the sheet in the second direction during the roll-to-roll travel, and
the third roller configured to support the other side of the sheet in the second direction during the roll-to-roll travel.

5. The apparatus of claim 1, wherein the transfer roller comprises:
a first hinge configured to hinge-couple one end of the first rotation shaft and one end of the second rotation shaft; and
a second hinge configured to hinge-couple the other end of the first rotation shaft and one end of the third rotation shaft,
wherein the second roller is configured to be tilted with respect to the first roller in a first rotational direction about the first hinge, and
the third roller is configured to be tilted with respect to the first roller in a second rotational direction opposite to the first rotational direction about the second hinge.

6. The apparatus of claim 5, further comprising:
a fixing bracket configured to fix the first hinge and the second hinge; and
a lifting bracket configured to raise and lower the other end of the second rotation shaft and the other end of the third rotation shaft in a third direction intersecting the first direction and the second direction.

7. The apparatus of claim 6, wherein the fixing bracket is configured to fixed to a rigid body, and the lifting bracket is configured to operated manually.

8. The apparatus of claim 6, wherein, when a first center of the sheet is not aligned with a second center of the transfer roller in the second direction during the roll-to-roll travel,
the lifting bracket is configured to raise the other end of the second rotation shaft and the other end of the third rotation shaft,
the second roller is configured to be tilted in the first rotational direction about the first hinge by the raising of the lifting bracket, and
the third roller is configured to be tilted in the second rotational direction about the second hinge by the raising of the lifting bracket, and
the sheet is configured to be guided toward the first roller by the tilting of the second roller and the third roller.

9. The apparatus of claim 5, further comprising:
a fixing bracket configured to fix the first hinge and the second hinge;
a first lifting bracket configured to raise and lower the other end of the second rotation shaft in a third direction intersecting the first direction and the second direction; and
a second lifting bracket configured to raise and lower the other end of the third rotation shaft in the third direction.

10. The apparatus of claim 9, wherein the fixing bracket is configured to be fixed to a rigid body, and the first lifting bracket and the second lifting bracket are configured to be operated manually.

11. The apparatus of claim 9, wherein, when a first center of the sheet is not aligned with a second center of the transfer roller in the second direction during the roll-to-roll travel,
one of the first lifting bracket and the second lifting bracket is configured to be raised selectively or lowered according to a direction in which the first center of the sheet is biased relative to the second center of the transfer roller in the second direction during the roll-to-roll travel.

12. The apparatus of claim 9, wherein, when a first center of the sheet is biased toward the second roller relative to a second center of the transfer roller in the second direction during the roll-to-roll travel,
the first lifting bracket is configured to raise the other end of the second rotation shaft,
the second roller is configured to be tilted in the first rotational direction about the first hinge by the raising of the lifting bracket, and
the sheet is configured to be guided toward the first roller by the tilting of the second roller.

13. The apparatus of claim 9, wherein, when a first center of the sheet is biased toward the third roller relative to a second center of the transfer roller in the second direction during the roll-to-roll travel,
the second lifting bracket is configured to raise the other end of the second rotation shaft,
the third roller is configured to be tilted in the second rotational direction about the second hinge by the raising of the lifting bracket, and
the sheet is configured to be guided toward the first roller by the tilting of the third roller.

14. A method for manufacturing battery cells, which winds a jelly-roll by supplying a sheet in a first direction in which roll-to-roll travel is performed, the method comprising:
supplying the sheet continuously in the first direction, the sheet being supported by a first roller, a second roller disposed at one side of the first roller in a second direction intersecting the first direction, and a third roller disposed at the other side of the first roller in the second direction;
monitoring whether a first center of the sheet is biased in the second direction during the roll-to-roll travel; and
guiding the sheet toward the first roller by tilting at least one of the second roller and the third roller when the first center of the sheet is biased in the second direction.

15. The method of claim 14, further comprising aligning the first center of the sheet with a second center of the first roller.

16. The method of claim 14, wherein the guiding of the sheet toward the first roller is performed by manually tilting one of the second roller and the third roller.

17. The method of claim 14, wherein the guiding of the sheet toward the first roller comprises:
guiding one end of the sheet supported by the second roller toward the first roller by tilting the second roller when the first center of the sheet is biased toward the second roller in the second direction; and
guiding the other end of the sheet supported by the third roller toward the first roller by tilting the third roller when the first center of the sheet is biased toward the third roller in the second direction.

18. The method of claim 17, wherein the tilting of the second roller and the tilting of the third roller are performed simultaneously.

19. The method of claim 17, wherein the tilting of the second roller and the tilting of the third roller are performed independently.
